(19) United States
(12) Patent Application Publication
(10) Pub. No.: US 2011/0056581 A1
(43) Pub. Date: Mar. 10, 2011

(54) CONSTRUCTION INDUSTRY PIPE FOR CONDUCTING FLUID MEDIUM HAVING RIGID SECTIONS ALTERNATING WITH FLEXIBLE SECTIONS

(75) Inventors: Domin Diels, Gierle (BE); Johny Van Den Bulcke, Dilsen-Stokkem (BE)

(73) Assignee: PLASTIFLEX BELGIUM, Paal-Beringen (BE)

(21) Appl. No.: 12/663,652

(22) PCT Filed: Jun. 9, 2008
(86) PCT No.: PCT/EP08/57156

§ 371 Date: Sep. 7, 2010

(30) Foreign Application Priority Data
Jun. 8, 2007 (EP) 07109856.0
Sep. 12, 2007 (EP) 07116250.7

(51) Int. Cl. F16L 11/11; B29C 47/00; B23P 11/00

(52) U.S. Cl. 138/120; 264/503; 29/428

(57) ABSTRACT

The invention relates to a construction industry pipe for use in the construction industry, such as for example a drain pipe or a central vacuum cleaner pipe or the like, comprising a tubular body having a substantially non-collapsible outer wall comprising rigid sections alternating with corrugated flexible sections. The invention further relates to a method for manufacturing such a pipe, which involves the technique of blow/vacuum moulding, and a method for installing a conduit system comprising such a pipe.

### TECHNICAL FIELD

The present invention relates to a construction industry pipe for conducting a fluid medium. The invention further relates to a method for manufacturing a construction industry pipe and a method for constructing a conduit system using a construction industry pipe.

### BACKGROUND ART

For drainage systems in and around houses or other buildings nowadays rigid pipe sections in different diameters and lengths are used. Mostly these pipe sections are connected with each other by means of different types of fittings, such as for example straight ones, T-fittings, 45° fittings, 90° fittings, etc. Mostly these pipes are made in PVC with the technique of extrusion. Due to the rigidity of the pipe sections, their length is limited in view of transportability, leading to the disadvantage that multiple sections have to be connected to each other in the drainage system. This is time consuming and hence costly.

Similarly, the circuits of central vacuum cleaning systems in walls, floors, ceilings and outside the building in the ground and such are built by means of similar rigid pipe sections which are coupled by suitable elbows, fittings and the like.

Apart from that, continuous processes are known for manufacturing mostly flexible hoses. An example of such a process is blow-moulding or vacuum-moulding in which molten plastic material is supplied to an extruder, from which the molten plastic material is introduced between two rotating mould chains. The mould chains face each other and rotate in opposite directions in relation to each other. Each mould chain comprises several separate mould parts and a semicylindrical score in longitudinal direction of the mould chain, which provides the outer surface of the pipe/hose to be produced. The molten plastic material is introduced in the mould at the point where the two mould chains come together. In the case of blow-moulding, pressurised air is blown through the centre of the cylinder of plastic material, so that it expands and is urged into the semicylindrical scores in the mould parts. In the case of vacuum-moulding, the mould parts are provided with narrow gaps, which extend circumferentially and are a few tenths of a millimetre wide, through which a vacuum is created around the cylinder of plastic material, also leading to expansion of the plastic material into the mould parts. Both pressurised air and vacuum can be used together at the same time. Because of the rotation of the mould chains the pipe/hose is pulled away from the extruder along with the separate mould parts of the two mould chains. Before the mould chains reach the point where their separate mould parts come apart, the individual moulds are cooled down, so that the plastic material solidifies. Finally the rotating mould chains separate and the mould parts are removed from the hose/pipe.

For example, in US 2002/0197430 A1 a blow-moulding process is applied for manufacturing a hose with bellows portions for application in vehicle engines. The bellows portions are chosen such that the finished hose bends at the bellows portions to take on a predetermined shape.

In U.S. Pat. No. 3,751,541 a blow-moulding process is applied for manufacturing thin plastic tubing which is partially corrugated and is suitable for making drinking straws, pipes for air-conditioning and ventilating systems in vehicles and the like.

### DISCLOSURE OF THE INVENTION

It is an aim of the present invention to provide a construction industry pipe with which construction of conduit systems for conducting fluid media in and around buildings and other fixed constructions can be facilitated.

It is another aim of the present invention to provide a method for manufacturing such a construction industry pipe.

These and other aims are achieved according to the invention with the construction industry pipe and the method showing the technical characteristics and steps of the independent claims.

As used herein, with “construction industry” is intended to mean the field of building and construction in general, i.e. the field of constructing any type of house, building or any other fixed construction, including road construction.

As used herein, with “construction industry pipe” is intended to mean a pipe which is specifically intended for use in the construction industry, i.e. in or around any type of house, building or any other fixed construction. This includes but is not limited to pipes for drainage systems for water such as waste water, rain water etc., sewage systems, water supply systems, air transport systems such as central vacuum cleaner systems, ventilation systems, etc. A common feature of all these conduit systems is that the outer wall of the used pipes is substantially non-collapsible, i.e. resists radial compression as long as the pipe is used for its intended purpose.

As used herein, with “fluid medium” is intended to mean any liquid, gas, smoke, aerosol, flowing solid or any mixture thereof or any other fluid medium known to the person skilled in the art.

As used herein, with “unitary tubular body” is intended to mean a hollow body which comprises multiple parts permanently connected to each other. These parts may form part of the same continuous layer of material or may be permanently welded, glued, bonded or otherwise fixed to each other.

As used herein, with a “continuous layer” of plastic material is meant that the material is continuous in both longitudinal and circumferential directions and free of welding seams, i.e. resulting from a continuous manufacturing process such as for example blow/vacuum-moulding. An alternative definition could be a “unitary tubular layer”.

The construction industry pipe according to the invention comprises a unitary tubular body having a substantially non-collapsible outer wall with a plurality of rigid sections alternating with corrugated flexible sections.

With the construction industry pipe of the invention, bends in a fluid medium conduit system, e.g. a drainage system, can be achieved simply by bending the pipe at the flexible sections, so there is no longer a need to connect multiple rigid sections to each other by means of a curved intermediate part like in the prior art. As a result, installation time and costs can be saved. At the same time, the substantially non-collapsible outer wall of the pipe, both at the rigid and flexible sections, ensures that the strength of the constructed conduit system is not adversely affected by the presence of the flexible sections and that a strength similar to that of prior art systems in which multiple rigid sections are joined together can be achieved.

Furthermore, the construction industry pipe of the invention can be manufactured in a continuous process up to a substantially indefinite length, as it can be bent and thus rolled up. As a result, the construction industry pipe can be stored and transported in the form of rolls, which can involve an additional cost reduction from the viewpoint of logistics.

The non-collapsibility of the outer wall is preferably achieved in that the outer wall has predetermined properties, e.g. choice of material(s), wall thickness, reinforcement(s) or other properties, chosen for resisting radial compression of the outer wall. In general, these predetermined properties are selected in function of the intended use of the pipe. In particular, they are selected such that at least the norms or rules imposed by law relevant to the intended use are met. It is evident that these norms or rules may differ for different intended purposes. For example, in embodiments where the pipe of the invention is intended for use in a drainage system in which waste water is to be conducted, the pipe needs to have a given strength to avoid collapse of the pipe after installation in the drainage system and the pipe needs to have a given minimal diameter in order to avoid obstruction of the pipe. Similarly, in embodiments where the pipe of the invention is intended for use in a central vacuum cleaner system in which an air stream is to be conducted, the pipe needs to have a given strength to be able to withstand the occurring pressure differences as a result of the air flow and again a minimal diameter is desired in view of avoiding obstructions, but the minimal strength and diameter requirements are different with respect to those of waste water drainage systems.

From the difference in technical field it is evident that the small pipes like the ones which are known from US 2002/0197430 A1 and U.S. Pat. No. 3,751,541 are not suitable for use in any field of the construction industry, since their size is too small and they do not have the required substantially non-collapsible outer wall.

In preferred embodiments according to the invention, the outer wall has predetermined properties for enabling use as a drain pipe as part of a waste water drainage system.

In other preferred embodiments according to the invention, the outer wall has predetermined properties for enabling use as a central vacuum cleaner pipe as part of a central vacuum cleaner system.

In other preferred embodiments according to the invention, the outer wall has predetermined properties for enabling use as a sewage pipe as part of a sewage system.

In other preferred embodiments according to the invention, the outer wall has predetermined properties for enabling use as an air ventilation pipe intended for use as part of an air ventilation system.

In general the outer wall of the construction industry pipe of the invention preferably comprises at least one continuous layer of plastic material having a first predetermined wall thickness at the rigid sections which is chosen for resisting radial compression and a second predetermined wall thickness at the corrugated flexible sections which is chosen for resisting radial compression while enabling flexibility. The tubular body preferably has a single layer forming these sections, but may also have other layers, such as for example an additional layer on the inside of the layer forming the flexible and rigid sections for making the inside of the corrugated sections more smooth. This additional layer may also be continuous or may be discontinuous and for example only provided inside the flexible sections. Another possible embodiment is to provide an intermediate layer between the inside layer and the outer layer in for example a regrind material or a recycled material, or a foamed layer as intermediate layer.

The first and second wall thicknesses may be substantially equal, but preferably the first wall thickness at the rigid sections is greater than the second wall thickness at the flexible sections. Such for example results by manufacturing the pipe by means of a blow/vacuum-moulding process in which a substantially constant extrusion speed and a substantially constant rotation speed of the mould chains are maintained. The wall thickness is thereby reduced at the corrugated parts, even though the speeds are kept constant, in view of the fact that the outer surface by the corrugated shape is relatively longer than at the rigid parts. So this embodiment has the advantage that it can be easily manufactured, since for example in the case of blow/vacuum moulding there is no need to vary the speeds. However, the speeds may be varied in alternative embodiments too.

As mentioned above, it is generally preferred that the wall thickness of the continuous layer forming the rigid and flexible sections is sufficient for being able to withstand a given force, which can for example be imposed by a norm.

In preferred embodiments of the construction industry pipe according to the invention, the flexible sections have an internal diameter which is substantially equal to that of the rigid sections. This means that the passage at the inside of the construction industry pipe has a substantially continuous cross-section, i.e. does not narrow at the corrugated sections, so that the flow of medium through the pipe in use is substantially not hampered by the corrugated sections.

In preferred embodiments of the construction industry pipe according to the invention, the flexible sections have a predetermined length which is chosen such with respect to the diameter of the flexible sections that a bend of at least 90° can be achieved. This is advantageous since bends of 90° often occur in the construction industry, e.g. in drainage systems of buildings. Preferably, the length of the flexible sections is greater than or equal to their diameter. This ratio of length/diameter can ensure that the flexible sections are long enough for achieving a desired flexibility. Preferably, the length of the flexible sections is between one and a half and three times their diameter. This means that they are also not made too long, which could affect the overall strength of the pipe.

In preferred embodiments of the construction industry pipe according to the invention, the rigid sections have a predetermined length which is chosen in function of a desired overall strength of the pipe. This means that the length of the rigid sections is preferably chosen such that they make up the majority of the length of the construction industry pipe of the invention, so that sufficient strength can be ensured. In other words, it is preferred that the rigid sections are longer than the flexible sections. Preferably, the length of the rigid sections is greater than or equal to their diameter, more preferably at least twice their diameter.

The diameter (=the outer diameter of the rigid sections) of the construction industry pipe of the invention is preferably a diameter which is common for construction industry pipes in the market, preferably larger than 10 mm, more preferably at least 30 mm, for example about 32, 40, 50, 90, 100, 110 or 125 mm or larger, even up to 600 mm or more.

In preferred embodiments of the construction industry pipe according to the invention, the construction industry pipe is provided with a coupling piece on at least one of its ends, the coupling piece being unitary with the body. The coupling piece is preferably integrally moulded with the body. This means that the coupling piece, which is provided for coupling the construction industry pipe to a subsequent part of the drainage system, is preferably uniformly manufactured with the tubular body and results from specific measures in the continuous manufacturing process, i.e. for example specific mould parts in the mould chain of a blow/vacuum-moulding process, so that the coupling piece is formed directly on the end of the construction industry pipe. The coupling piece is preferably shaped such that it is complementary with existing fittings.

In preferred embodiments, the coupling piece comprises a widened part with an internal annular recess for holding a sealing ring, the internal diameters of which are chosen such that the coupling piece snugly fits around a rigid section of a subsequent pipe. Since the rigid sections have the same dimensions, this has the advantage that the coupling piece is complementary to each of the rigid sections, so that the subsequent pipe can be cut short if necessary by cutting off one or more sections without affecting its ability to be connected to the previous pipe.

In alternative embodiments, the construction industry pipe of the invention may also be provided with complementary male and female parts at its opposite ends, with snap-fitting connecting rings/recesses or the like.

In preferred embodiments of the construction industry pipe according to the invention, the construction industry pipe is provided with length markings on its outside. This can help the installers to cut off the construction industry pipe at the exact length. The application of these markings on the construction industry pipe can be easily integrated in the blow/vacuum-moulding process by means of suitable engravings or shapes in the mould parts of the mould chains.

In preferred embodiments of the construction industry pipe according to the invention, at least one of the flexible sections is formed by an extensible concertina-type hinge. This type of hinges is in principle well-known from the field of drinking straws, the difference according to the invention being that larger diameters are used and that the strength of the outer wall is taken into account so that the required non-collapsibility is achieved to enable use in the construction industry. The extensible concertina-type hinge has the advantage that it maintains its shape once it is bent to a certain angle. Furthermore, the inclusion of one or more of such hinges in this embodiment of the construction industry pipe has the advantage that the pipe can be extended to a certain extent, which is convenient if upon installation it appears that the pipe is a few centimetres too short.

The construction industry pipe of the invention is preferably manufactured by means of a blow/vacuum-moulding process, comprising the steps of (a) extruding a tube of molten plastic material between two rotating mould chains comprising multiple mould parts with longitudinal scores which come together for forming the outside of the construction industry pipe, (b) expanding the tube of molten plastic material by means of a pressure difference between the outside of and the inside of the tube, such that the molten plastic material is urged into the longitudinal scores in the mould parts, (c) cooling the mould parts before removal from the formed construction industry pipe.

In order to achieve the substantially non-collapsible outer wall, predetermined steps are introduced in this process, such as for example controlling the extrusion speed relative to the rotation speed of the mould chains in such a way that the outer wall of the formed tubular body has a predetermined wall thickness for resisting radial compression.

Preferably, the rigid and flexible parts are formed by means of separate mould parts, since this facilitates manufacturing the mould parts. In other words, it is preferred that the mould chains comprise first mould parts shaped for forming the rigid sections and second mould parts shaped for forming the flexible sections, each chain having a sequence of one or more first mould parts alternating with a sequence of one or more second mould parts. As mentioned above, one or more specific mould parts may be added in each of the mould chains for shaping a coupling piece integrally with the body of the construction industry pipe.

As mentioned above, the extrusion speed and the rotation speed of the mould chains are preferably substantially constant, since this simplifies control of the process and can simultaneously achieve that the rigid and corrugated sections are made with different wall thicknesses, such that they are respectively rigid and flexible.

As mentioned above, the construction industry pipe of the invention is preferably stored on a roll, which is possible by the presence of the flexible sections and has advantages from the viewpoint of logistics.

In a preferred embodiment, the method further comprises the step of co-extruding an inner tube of molten plastic for forming a smooth additional layer at least on the inside of the flexible sections. When this layer is provided inside the flexible sections only, extrusion of the inner tube is started and stopped in synchronisation with passage of the second mould parts forming the flexible sections.

With the construction industry pipe of the invention, a fluid medium conduit system is constructed as follows: providing the construction industry pipe in a desired length; connecting a first end of the pipe to a first part of the conduit system; placing the pipe in a suitable configuration while bending at least one of the flexible sections, such that a second end of the pipe approaches a second part of the conduit system; connecting the second end of the pipe to the second part. The step of providing the construction industry pipe in a desired length preferably comprises unrolling the construction industry pipe from a roll and cutting the pipe in the desired length.

Depending on the intended purpose, the construction industry pipe may subsequently be embedded in a covering layer such as for example cement, concrete or plaster used for evening a wall or floor surface (e.g. in the case of drain systems), or the construction industry pipe may be hidden in hollow wall or floor structures (e.g. in the case of central vacuum cleaner systems or air ventilation systems), or the construction industry pipe may be embedded in the ground in conduit systems outside buildings (e.g. drainage or sewage systems).

### BRIEF DESCRIPTION OF THE DRAWINGS

The invention will be further elucidated by means of the following description and the appended figures.

FIG. 1 shows a perspective view of an embodiment of the construction industry pipe of the invention, with part of the wall broken away to show the interior of the pipe.

FIG. 2 shows a perspective view of an embodiment of a process for manufacturing the construction industry pipe of FIG. 1.

FIGS. 3 and 4 show a perspective view of another embodiment of the construction industry pipe of the invention, comprising a coupling piece. In these figures the pipes are cut in half to show the interior and the coupling is shown in an enlarged view.

FIG. 5 shows a cross-sectional view of another preferred embodiment of the construction industry pipe of the invention.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

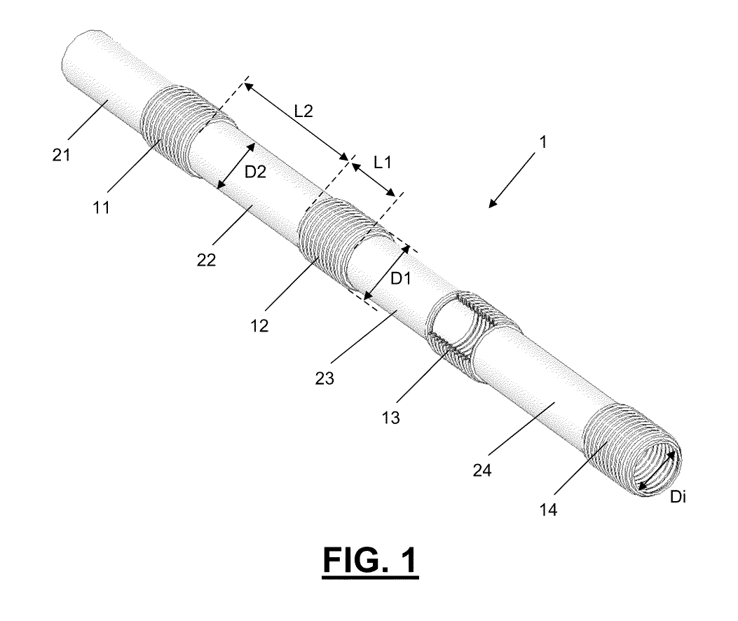

FIG. 1 generally shows a preferred embodiment of a construction industry pipe according to the invention which is specifically intended for use in the construction industry, i.e. in or around any type of house, building or any other fixed construction. This means that the outer wall of the pipe has predetermined properties enabling use as for example pipes for drainage systems for water such as waste water, rain water etc., sewage systems, water supply systems, air transport systems such as central vacuum cleaner systems, ventilation systems, etc. A common feature of all these conduit systems is that the outer wall of the pipe is substantially non-collapsible, i.e. resists radial compression as long as the pipe is used for its intended purpose. Of course, the outer wall may collapse when subject to extreme forces, but it is to be understood that such extreme forces do not occur during normal use of the pipe for the intended purpose and that the outer wall is designed to withstand the forces which do occur during the normal use.

The pipe of FIG. 1 comprises a tubular body 1, which is preferably symmetrical around its longitudinal axis, comprising rigid sections 21-24 alternating with corrugated flexible sections 11-14. The tubular body 1 is manufactured from a single continuous layer of plastic material, which forms these sections. In alternative embodiments (not shown), the body 1 may also have other layers, such as for example an additional layer on the inside of the layer forming the flexible and rigid sections for making the inside of the corrugated sections 11-14 more smooth.

In cross section, the pipe of FIG. 1 has a circular shape. Alternatively, the shape may for example also be oval or polygonal or any other shape deemed suitable by the person skilled in the art. The corrugated sections may also be spirally wound as is common for corrugated blow-moulded hoses. The internal diameter of the pipe of FIG. 1 is substantially continuous, but may also be varied in alternative embodiments. The rigid sections are preferably substantially straight with a continuous diameter as shown, but may also be bent, curved or angled and for example conical with a varying diameter. The plastic material may for example be PP, but other materials known to the person skilled in the art are also possible, such as for example PVC, PE, ABS, PA or other.

With the construction industry pipe of FIG. 1, bends in the fluid conducting circuit in or around a building or in the ground can be achieved easily by bending the construction industry pipe 1, so there is no longer a need to connect two straight rigid sections to each other by means of a curved intermediate part like in the prior art. As a result, installation time and costs can be saved.

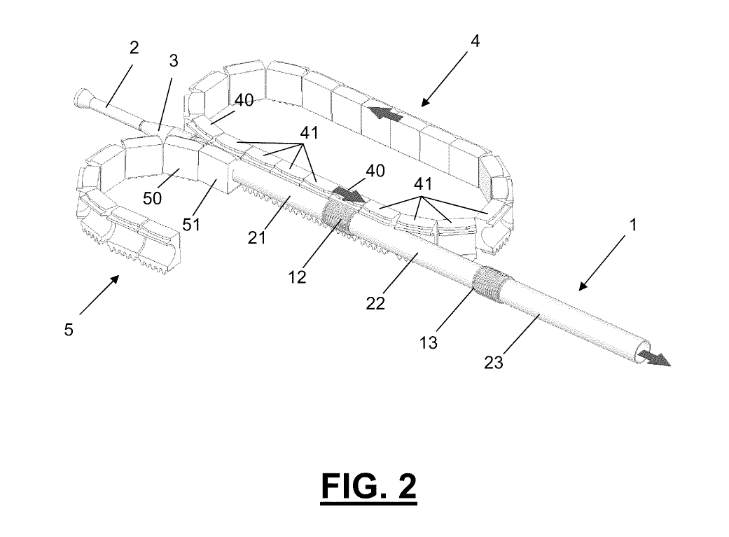

Furthermore, the construction industry pipe of FIG. 1 can be manufactured in a continuous process, such as for example the process shown in FIG. 2, up to a substantially indefinite length and can be rolled up. As a result, the construction industry pipe can be stored and transported in the form of rolls, which can involve an additional cost reduction from the viewpoint of logistics.

In embodiments where the pipe of FIG. 1 is intended for use in a drainage system in which waste water is to be conducted, the pipe needs to have a given strength to avoid collapse of the pipe after installation in the drainage system. Similarly, in embodiments where the pipe of FIG. 1 is intended for use in a central vacuum cleaner system in which an air stream is to be conducted, the pipe needs to have a given strength to be able to withstand the occurring pressure differences. In general, it has to be made sure that the wall thickness of the continuous layer forming the rigid and flexible sections is sufficient for being able to withstand a given force, which can for example be imposed by a norm. For example, in case the pipe is manufactured in PVC or PP, suitable wall thicknesses for the rigid sections are 1.2 mm, 1.8 mm, 2 mm, 3 mm and 3.2 mm, also depending on the diameter of the pipe.

In the pipe of FIG. 1, the rigid sections 21-24 have a greater wall thickness than the flexible sections 11-14. Such for example results by manufacturing the pipe by means of the blow/vacuum-moulding process of FIG. 2 in which a substantially constant extrusion speed and a substantially constant rotation speed of the mould chains 4, 5 are maintained. The wall thickness is thereby reduced at the corrugated parts 11-14, even though the speeds are kept constant, in view of the fact that the outer surface by the corrugated shape is relatively longer than at the rigid parts 21-24. This shows that the pipe can be easily manufactured, since in the case of the blow/vacuum moulding process of FIG. 2 there is no need to vary the speeds. However, the speeds may be varied in alternative embodiments too.

In the embodiment of the construction industry pipe of FIG. 1, the flexible sections 11-14 have an internal diameter Di which is substantially equal to that of the rigid sections 21-24. This means that the passage at the inside of the construction industry pipe 1 has a substantially continuous cross-section, i.e. does not narrow at the corrugated sections 11-14, so that the flow of fluid medium through the pipe in use is substantially not hampered by the corrugated sections.

In the embodiment of the construction industry pipe of FIG. 1, the flexible sections have a predetermined length L1 which is chosen such with respect to the diameter D1 of the flexible sections that a bend of at least 90° can be achieved. This is advantageous since bends of 90° often occur in drainage systems of buildings. In the embodiment of FIG. 1 the length L1 of the flexible sections 11-14 is slightly greater than their diameter D1. This ratio of length/diameter L1/D1 can ensure that the flexible sections are long enough for achieving the desired flexibility. In other preferred embodiments of pipes according to FIG. 1 the length of the flexible sections is between one and a half and three times their diameter. This means that they are also not made too long, which could affect the overall strength of the pipe.

In the embodiment of the construction industry pipe of FIG. 1, the rigid sections 21-24 have a predetermined length L2 which is chosen in function of a desired strength of the pipe. This means that the length L2 of the rigid sections 21-24 is preferably chosen such that they make up the majority of the length of the construction industry pipe 1, so that sufficient strength can be ensured. As shown, it is preferred that the rigid sections 21-24 are longer than the flexible sections 11-14. In the embodiment of FIG. 1, the length L2 of the rigid sections is much greater than their diameter D2. In other preferred embodiments of pipes according to FIG. 1 the length of the rigid sections is at least twice their diameter.

The diameter (=the outer diameter of the rigid sections) of the construction industry pipe of FIG. 1 is preferably a diameter which is common for construction industry pipes in the market, preferably larger than 10 mm, more preferably at least 30 mm, for example about 32, 40, 50, 90, 100, 110 or 125 mm. However, it is evident that other diameters are also possible, even up to 600 mm or more.

In other preferred embodiments (not shown) the construction industry pipe can be provided with length markings on its outside. This can help the installers to cut off the construction industry pipe at the exact length. The application of these markings on the construction industry pipe can be easily integrated in the blow/vacuum-moulding process of FIG. 2 by means of suitable engravings or shapes in the mould parts of the mould chains 4, 5.

The construction industry pipe 1 can be manufactured by means of the blow/vacuum-moulding process of FIG. 2. This comprises the following steps. A tube 3 of molten plastic material is extruded from a die 2 between two rotating mould chains 4, 5 comprising multiple mould parts 40-41, 50-51 with longitudinal scores which come together for forming the outside of the construction industry pipe 1. The tube 3 of molten plastic material is expanded by means of a pressure difference between the outside of and the inside of the tube, such that the molten plastic material is urged into the longitudinal scores in the mould parts 40-41, 50-51. The mould parts are cooled before removal from the formed construction industry pipe 1.

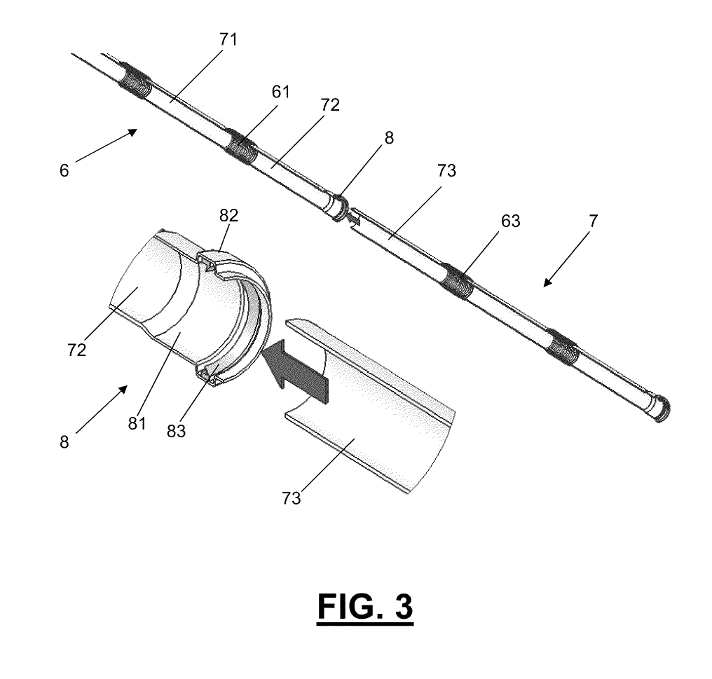

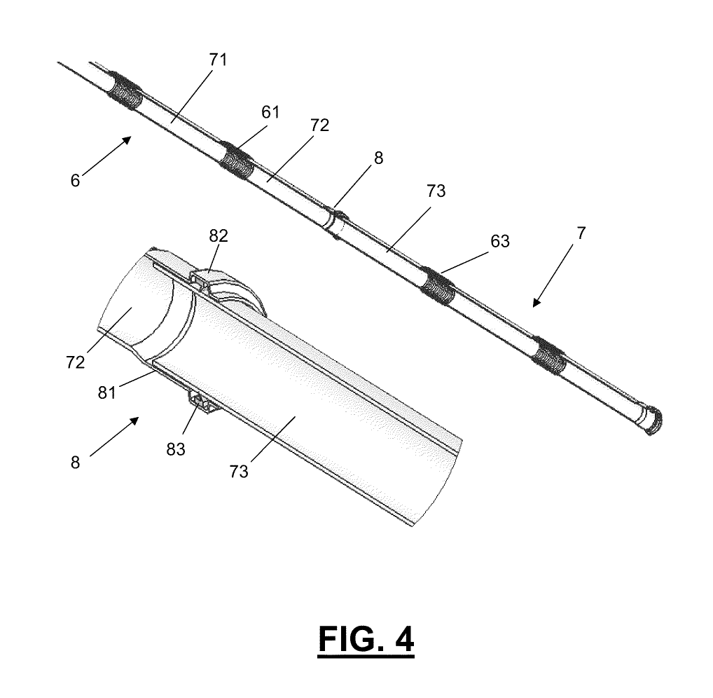

As shown, the rigid and flexible parts of the construction industry pipe 1 are formed by means of separate mould parts, since this facilitates manufacturing the mould parts themselves. In FIG. 2, the mould chains 4 and 5 respectively comprise first mould parts 41, 51 shaped for forming the rigid sections 21-24 and second mould parts 40, 50 shaped for forming the flexible sections 11-14. Each chain 4, 5 has a sequence of four first mould parts 41 alternating with one second mould part 40, 50. One or more specific mould parts may be added in each of the mould chains 4, 5 for shaping a coupling piece 8 integrally with the body 6, 7 of the construction industry pipe, like in the embodiment of FIGS. 3 and 4.

As mentioned above, the extrusion speed of the tube 3 at the die 2 and the rotation speed of the mould chains 4, 5 are substantially constant, since this simplifies control of the process and can simultaneously achieve that the rigid and corrugated sections are made with different wall thicknesses, such that they are respectively rigid and flexible.

The construction industry pipe 1 of FIGS. 1 and 2 is preferably stored on a roll, which is possible by the presence of the flexible sections 11-14 and has advantages from the viewpoint of logistics.

In a preferred embodiment (not shown), the process of FIG. 2 may further comprise the co-extrusion of an inner tube of molten plastic for forming a smooth additional layer at least on the inside of the flexible sections 11-14. When this layer is provided inside the flexible sections only, extrusion of the inner tube is started and stopped in synchronisation with passage of the second mould parts 40, 50 forming the flexible sections 11-14.

In the preferred embodiment of FIGS. 3 and 4, the construction industry pipe is provided with a coupling piece 8 on one of its ends, the coupling piece 8 being integrally moulded with the body 6, 7 and being complementary to the other end of the body 6, 7 which is formed by one of the rigid sections 73. FIGS. 3 and 4 show respectively two construction industry pipes 6, 7 connected to each other by means of this coupling piece 8. The coupling piece 8 is unitary with the tubular body 6, 7 and results from specific measures in the continuous manufacturing process, i.e. for example specific mould parts in the mould chains 4, 5 of the blow/vacuum-moulding process of FIG. 2, so that the coupling piece 8 is formed directly on the end of the construction industry pipe without needing an additional process step.

The blow/vacuum-moulded pipe with the integrated coupling piece may be cut in sections at the coupling piece in a subsequent step on the manufacturing site, or may be stored on a roll with the cutting then taking place at the construction site where the pipe is used for installing a conduit. In the latter case, the pipe can only be cut where necessary and multiple sections can be left as one if a longer stretch of pipe is desired, i.e. it is not essential to cut the pipe at each coupling piece.

In the embodiment shown in FIGS. 3 and 4, the coupling piece 8 comprises a widened part 81 with an internal annular recess 82 for holding a sealing ring 83. The internal diameter of the widened part 81 and the sealing ring 83 are chosen such that the coupling piece snugly fits around the rigid section 73 of the subsequent pipe 7. Since the rigid sections 71, 72, 73 all have the same dimensions, the coupling piece 8 is complementary to each of these, so that the subsequent pipe 7 can be cut short if necessary, by cutting off one or more sections or part of section 73.

In alternative embodiments (not shown), the construction industry pipe of the invention may also be provided with complementary male and female parts at its opposite ends, with snap-fitting connecting rings/recesses or the like.

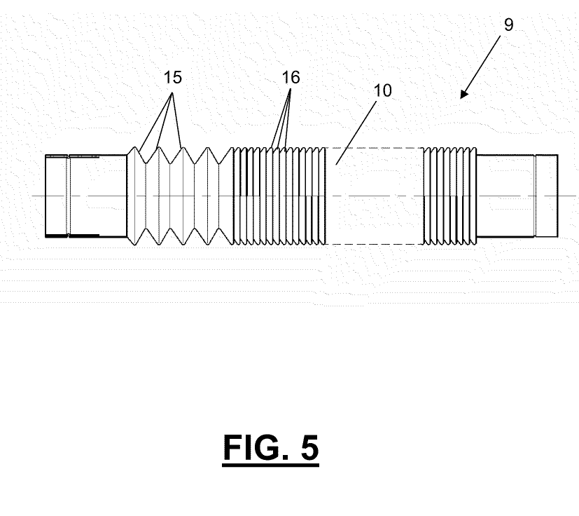

In the preferred embodiment of the construction industry pipe 9 shown in FIG. 5, at least one of the flexible sections is formed by an extensible concertina-type hinge 10. This type of hinges, which is well-known from the field of drinking straws, comprises a plurality of corrugations of which the upstanding legs are in such a way different that the corrugations can collapse into each other. As a result of this, each of the corrugations is extensible and bendable, while it substantially maintains the shape it is given. In FIG. 5, some of the corrugations 15 are shown in extended state whereas others 16 are shown in the collapsed state.

The use of this extensible concertina-type hinge 10 has the advantage that the corrugated section maintains its shape once it is bent to a certain angle. Furthermore, the construction industry pipe 9 can be extended to a certain extent, which is convenient if upon installation it appears that the pipe is a few centimetres too short.

The material of the pipe 9 is one of the factors which influences the strength which is needed for extending/collapsing the corrugations of the hinge 10. The material may for example be PP, but other materials known to the person skilled in the art are also possible, such as for example PVC, PE, ABS, PA, . . . .

In the embodiments shown in FIGS. 1-5, the rigid and flexible sections are constructed from the same layer of plastic material. It is however also possible to construct the rigid and flexible sections in different materials, so each time switching the material in the extruder at each transition from a flexible to a rigid section and vice versa.

The outer wall of the pipes shown in FIGS. 1-5 may for example have predetermined properties for enabling use of the pipe as part of a waste water drainage system. An example of suitable properties for this use are the following:
nominal diameter: 10 to 600 mm;
outer wall: continuous layer of PVC, PE or PP with a wall thickness of about 1.8 mm at the rigid sections and a wall thickness of about 1 mm at the flexible sections.

The outer wall of the pipes shown in FIGS. 1-5 may for example have predetermined properties for enabling use of the pipe as part of a sewage system. An example of suitable properties for this use are the following:
nominal diameter: 30 to 600 mm;
outer wall: continuous layer of PE or PP with a wall thickness of about 1.8 mm at the rigid sections and a wall thickness of about 1 mm at the flexible sections.

The outer wall of the pipes shown in FIGS. 1-5 may for example have predetermined properties for enabling use of the pipe as part of a central vacuum cleaner system. An example of suitable properties for this use are the following:
nominal diameter: 32 to 100 mm;
outer wall: continuous layer of PVC, PE or PP with a wall thickness of about 1 mm at the rigid sections and a wall thickness of about 0.6 mm at the flexible sections.

The outer wall of the pipes shown in FIGS. 1-5 may for example have predetermined properties for enabling use of the pipe as part of an air ventilation system. An example of suitable properties for this use are the following:
nominal diameter: 80 to 600 mm;
outer wall: continuous layer of PVC, PE or PP with a wall thickness of about 1 mm at the rigid sections and a wall thickness of about 0.6 mm at the flexible sections.

In each of the cases, other materials and wall thicknesses are possible, as well as an outer wall having multiple layers.

1-30. (canceled)

31. A construction industry pipe for conducting a fluid medium, the pipe having a diameter larger than 10 mm and comprising a unitary tubular body having a substantially non-collapsible outer wall with predetermined properties for resisting radial compression of the outer wall, the unitary tubular body comprising a plurality of rigid sections alternating with corrugated flexible sections, the outer wall comprising at least one continuous layer of plastic material having a first predetermined wall thickness at the rigid sections which is chosen for resisting radial compression and a second predetermined wall thickness at the corrugated flexible sections which is chosen for resisting radial compression while enabling flexibility, wherein the rigid sections are longer than the flexible sections and wherein the first predetermined wall thickness is greater than the second.

32. A construction industry pipe according to claim 31, wherein the pipe has a diameter of at least 30 mm.

33. A construction industry pipe according to claim 31, wherein the pipe is manufactured in PVC or PP and the first wall thickness of the rigid sections is at least 1.2 mm.

34. A construction industry pipe according to claim 31, wherein the flexible sections have an internal diameter which is substantially equal to that of the rigid sections.

35. A construction industry pipe according to claim 31, wherein the flexible sections have a predetermined length which is chosen such with respect to the diameter of the flexible sections that a bend of at least 90° can be achieved.

36. A construction industry pipe according to claim 35, wherein the length of the flexible sections is greater than or equal to their diameter.

37. A construction industry pipe according to claim 35, wherein the length of the flexible sections is between one and a half and three times their diameter.

38. A construction industry pipe according to claim 31, wherein the rigid sections have a predetermined length which is chosen in function of a desired strength of the pipe.

39. A construction industry pipe according to claim 38, wherein the length of the rigid sections is greater than or equal to their diameter.

40. A construction industry pipe according to claim 38, wherein the length of the rigid sections is at least twice their diameter.

41. A construction industry pipe according to claim 31, wherein the diameter of the body is greater than 10 mm.

42. A construction industry pipe according to claim 31, wherein the construction industry pipe is provided with a coupling piece on at least one of its ends, the coupling piece being integrally moulded with the body.

43. A construction industry pipe according to claim 42, wherein the coupling piece comprises a widened part with an internal annular recess for holding a sealing ring, the internal diameters of which are chosen such that the coupling piece snugly fits around a rigid section of a subsequent pipe.

44. A construction industry pipe according to claim 31, wherein the construction industry pipe is provided with length markings on its outside.

45. A construction industry pipe according to claim 31, wherein the tubular body comprises an additional layer on the inside of the layer forming the flexible and rigid sections for making the inside of the corrugated flexible sections more smooth.

46. A construction industry pipe according to claim 45, wherein the additional layer is discontinuous and only provided inside the flexible sections.

47. A construction industry pipe according to claim 31, wherein at least one of the flexible sections is formed by an extensible concertina-type hinge.

48. A method for manufacturing a construction industry pipe having a diameter larger than 10 mm, the pipe comprising a unitary tubular body having a substantially non-collapsible outer wall with predetermined properties for resisting radial compression of the outer wall, the unitary tubular body comprising a plurality of rigid sections alternating with corrugated flexible sections, the outer wall comprising at least one continuous layer of plastic material having a first predetermined wall thickness at the rigid sections which is chosen for resisting radial compression and a second predetermined wall thickness at the corrugated flexible sections which is chosen for resisting radial compression while enabling flexibility, the rigid sections being longer than the flexible sections and the first predetermined wall thickness being greater than the second predetermined wall thickness, the method comprising the steps of:
a) extruding a tube of molten plastic material between two rotating mould chains comprising multiple mould parts with longitudinal scores which come together for forming the outside of the rigid and flexible corrugated sections of the construction industry pipe,
b) expanding the tube of molten plastic material by means of a pressure difference between the outside of and the inside of the tube, such that the molten plastic material is urged into the longitudinal scores in the mould parts, thereby forming the pipe having a diameter larger than 10 mm and comprising the unitary tubular body having the plurality of rigid sections alternating with corrugated flexible sections, with the first predetermined wall thickness at the rigid sections greater than the second predetermined wall thickness at the corrugated flexible sections,
c) cooling the mould parts before removal from the formed construction industry pipe.

49. A method according to claim 48, wherein the speed of extrusion of said tube and the speed of rotation of said mould chains are controlled in such a way with respect to each other that the formed construction industry pipe has the first predetermined wall thickness at the rigid sections and the second predetermined wall thickness at the corrugated flexible sections.

50. A method according to claim 48, wherein the mould chains comprise first mould parts shaped for forming the rigid sections and second mould parts shaped for forming the flexible sections, each chain having a sequence of one or more first mould parts alternating with a sequence of one or more second mould parts.

51. A method according to claim 48, wherein each of the mould chains comprises at least one mould part for forming a coupling piece integrally with the body of the construction industry pipe.

52. A method according to claim 48, wherein the extrusion speed and the rotation speed of the mould chains are substantially constant.

53. A method according to claim 48, further comprising the step of storing the construction industry pipe on a roll.

54. A method according to claim 48, further comprising the step of co-extruding an inner tube of molten plastic for forming a smooth additional layer at least on the inside of the flexible sections.

55. A method according to claim 54, wherein extrusion of the inner tube is started and stopped in synchronisation with passage of the second mould parts forming the flexible sections.

56. Method for constructing a fluid medium conduit system using a construction industry pipe having a diameter larger than 10 mm and comprising a unitary tubular body having a substantially non-collapsible outer wall with predetermined properties for resisting radial compression of the outer wall, the unitary tubular body comprising a plurality of rigid sections alternating with corrugated flexible sections, the outer wall comprising at least one continuous layer of plastic material having a first predetermined wall thickness at the rigid sections which is chosen for resisting radial compression and a second predetermined wall thickness at the corrugated flexible sections which is chosen for resisting radial compression while enabling flexibility, wherein the rigid sections are longer than the flexible sections and wherein the first predetermined wall thickness is greater than the second, the method comprising the steps of: (i) providing the construction industry pipe in a desired length; (ii) connecting a first end of the pipe to a first part of the conduit system; (iii) placing the pipe in a suitable configuration while bending at least one of the flexible sections, such that a second end of the pipe approaches a second part of the conduit system; and (iv) connecting the second end of the pipe to the second part.

57. Method according to claim 56, wherein step (i) comprises unrolling the construction industry pipe from a roll and cutting the pipe in the desired length.
